(19) United States
(12) Patent Application Publication
(10) Pub. No.: US 2025/0128198 A1
(43) Pub. Date: Apr. 24, 2025

(54) FILTER CARTRIDGE FOR A COALESCER

(71) Applicant: CECO Environmental Corp., Dallas, TX (US)

(72) Inventors: Mathews Joshua Thundyil, Dallas, TX (US); William Roy McDoniel, Dallas, TX (US); Carl William Hahn, Dallas, TX (US); David Michael Seeger, Dallas, TX (US)

(21) Appl. No.: 18/493,228

(22) Filed: Oct. 24, 2023

(51) Int. Cl. B01D 46/52; B01D 46/24

(52) U.S. Cl. CPC B01D 46/522; B01D 46/2411

(57) ABSTRACT

A filter cartridge for a coalescer includes an inner support cylinder, an outer support cylinder, and a filter medium. The inner support cylinder defines a fluid entry passageway inboard of the cylinder. The outer support cylinder is concentrically spaced from the inner support cylinder and defines a fluid exit outboard of the cylinder. The inner support cylinder and the outer support cylinder together define a central fluid passageway between them. The filter medium is positioned in the central fluid passageway and includes a number of pleats with different lengths.

### RELATED APPLICATIONS

The present non-provisional patent application claims priority benefit with regard to all common subject matter, of prior-filed U.S. provisional patent application Ser. No. 63/420,942, filed Oct. 31, 2022, titled MAXIMIZING SURFACE AREA IN COALESCERS. The above-referenced prior-filed patent application is hereby incorporated by reference into the present patent application in its entirety.

### BACKGROUND

Coalescer filtration separates and removes liquid contaminants and aerosols from liquids and gases. For example, coalescers are often used in the gas and liquid processing industry to remove unwanted moisture and/or other liquid contaminants from various petroleum-based liquids or other gas and liquid streams. The velocity of fluid streams through a coalescer is often a critical design parameter (“media velocity”), and there is typically a limit to such flow.

### SUMMARY OF INVENTION

Embodiments of the present invention allow for lower media velocity through coalescers by providing an improved coalescer filter cartridge design. A filter cartridge constructed in accordance with an embodiment of the invention broadly comprises a perforated inner support cylinder, a perforated outer support cylinder, and a filter medium between the support cylinders. As explained in more detail below, the filter medium is uniquely configured to minimize media velocity through the filter cartridge.

The inner support cylinder defines a fluid entry passageway in its interior volume for receiving a gas or liquid stream (also referred to herein as a “fluid stream” or “fluid streams”) from a gas and/or liquid processing facility such as a petrochemical production facility. The outer support cylinder is concentrically spaced from the inner support cylinder and defines a fluid exit outboard of the cylinder. The inner support cylinder and the outer support cylinder together define a central fluid passageway between them. The filter medium is positioned in the central fluid passageway and includes a number of pleats.

Gas or liquid streams flow into the fluid entry passageway, through the inner support cylinder, through the filter medium, and finally through the outer support cylinder before exiting the coalescer. Liquid contaminants in the fluid stream coalesce on the filter medium and exit the filter cartridge after which they are collected and removed from the coalescer.

In accordance with an important aspect of the invention, the pleats in the filter medium are configured to maximize the surface area of the filter medium exposed to the fluid stream so that the media velocity through the coalescer can be minimized. To that end, the pleats have varied lengths, with some relatively longer pleats and some relatively shorter pleats. In one particular embodiment of the invention, the pleats are M-shaped, with some adjacent pleats having different lengths. Other important aspects of the filter cartridge are discussed and claimed below.

### BRIEF DESCRIPTION OF THE DRAWING FIGURES

FIG. 1 is a schematic diagram of an exemplary coalescer in which the filter cartridge of the present invention may be implemented.

FIG. 2 is a cross sectional view of a prior art filter cartridge that may be used in coalescers.

FIG. 3 is a cross sectional view of a filter cartridge constructed in accordance with an embodiment of the present invention.

### DETAILED DESCRIPTION

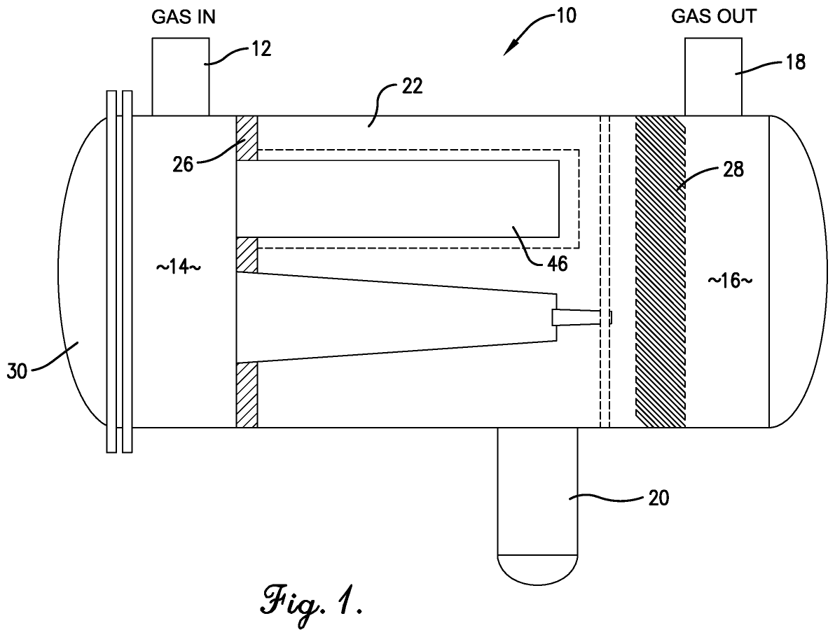

An exemplary coalescer 10 in which one or more filter cartridges of the present invention may be used is shown in FIG. 1. The coalescer 10 removes liquid contaminants from a fluid stream of a gas or liquid processing facility such as a petrochemical production facility. The particular coalescer 10 shown and described herein may be replaced with other coalescers and filtering equipment without departing from the scope of the invention. An alternative configuration where the coalescer is oriented vertically, with one or more filter cartridges of the present invention may be envisaged, and due to the vertical configuration, the elements may need to be retained in place with a nut and installed on the dividing tubesheet through a top opening or manway. In both cases, the vessel comprises two chambers with a tubesheet or manifold that separates the influent from the effluent chamber.

The coalescer 10 includes an inlet port 12 and inlet chamber 14 for receiving a fluid stream of a gas or liquid processing facility before liquid contaminants have been removed; an effluent chamber 16 and outlet port 18 for discharging the filtered fluid stream back to the gas or liquid processing facility; a drain 20 for collecting and discharging contaminants that have been removed from the fluid stream; and at least one separation stage 22 between the inlet chamber 14 and effluent chamber 16. Each separation stage 22 houses at least one filter cartridge 46 as described in more detail below.

The filter cartridges 46 are sealed in the separation stage 22 by means of an O-ring, gasket, or other seal 26. A mesh/vane final separator 28 may be positioned between the filter cartridges 46 and the outlet port 18 for removing additional contaminants from the fluid stream. A removable closure 30 is located near the inlet 12 to allow installation of the filter cartridges into the coalescer and subsequent removal and replacement of the cartridges.

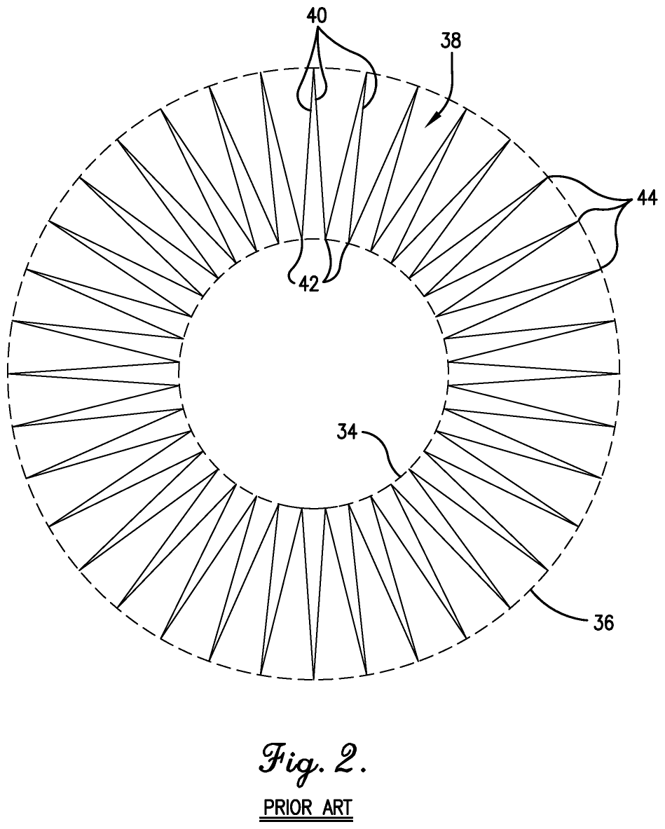

FIG. 2 illustrates a prior art coalescer filter cartridge 32. The filter cartridge 32 includes an inner support 34, an outer support 36, and a pleated filter medium 38 between the supports. The pleated filter medium has a number of fixed length legs 40, each terminating in an inner pleat tip 42 that touches the inner support 34 and an outer pleat tip 44 that touches the outer support 36. The pleated filter medium 38 increases the filter surface area in a fixed cartridge envelope (governed by the inner and outer supports). Typically, the larger the inner diameter of the inner support, the lower the pressure drop entering the filter cartridge. For a given inner diameter, the optimal spacing of the pleat tips is selected for a particular fluid and separation requirement. Because all the pleats are the same length, the spacing between the outer pleat tips is greater than the spacing of the inner pleat tips.

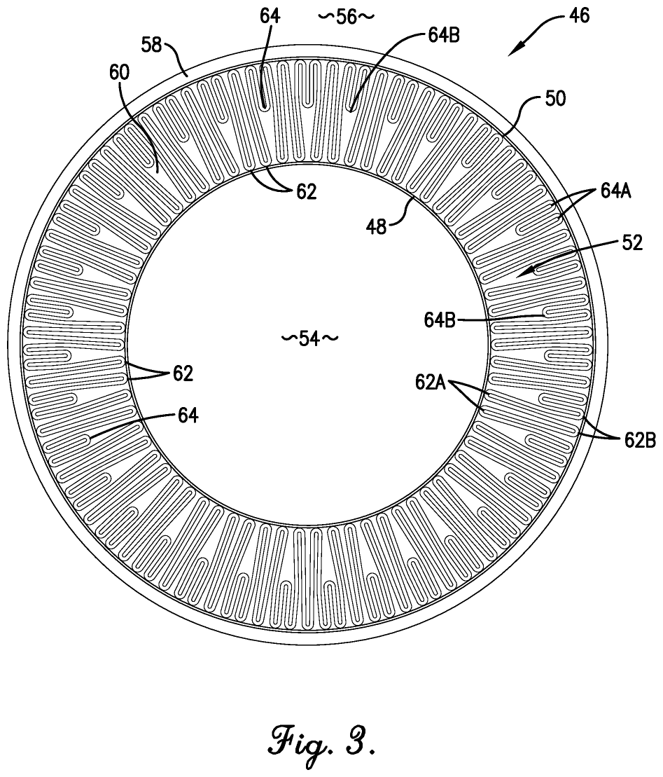

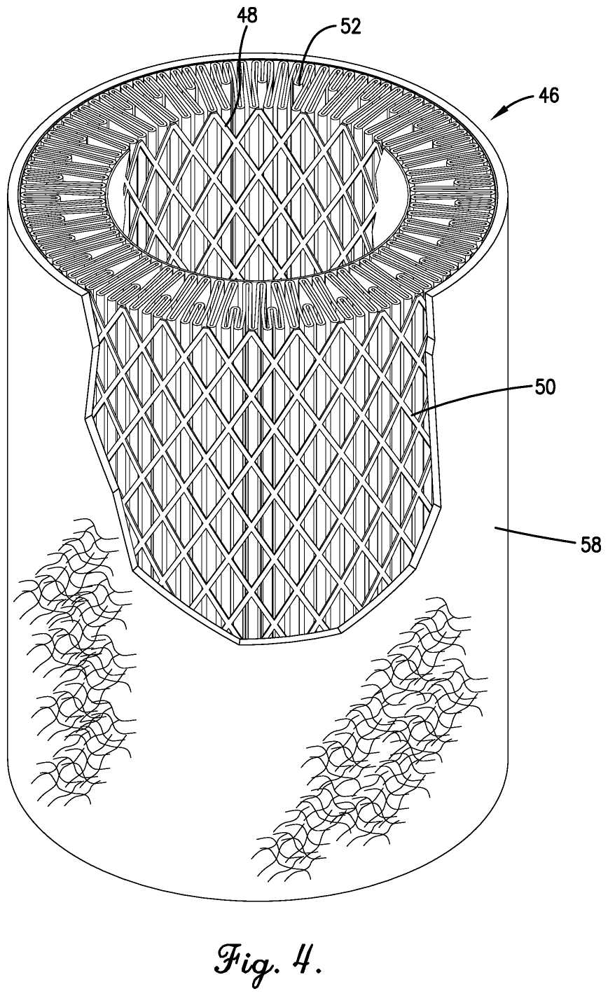

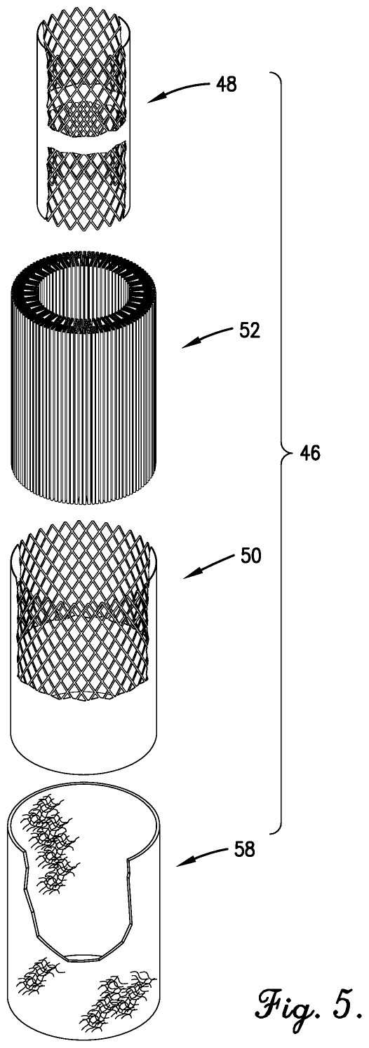

FIGS. 3-5 illustrate a filter cartridge 46 constructed in accordance with an embodiment of the invention. The filter cartridge 46 broadly comprises a perforated inner support cylinder 48, a perforated outer support cylinder 50, and a filter medium 52 between the support cylinders.

The inner support cylinder 48 defines a fluid entry passageway 54 in its interior volume for receiving a gas or liquid stream (also referred to herein as a “fluid stream” or “fluid streams”) from a gas and/or liquid processing facility such as a petrochemical production facility. The inner support cylinder 48 may be formed of a metal mesh, with the perforations comprising openings in the mesh. The support cylinder may also be formed of other suitable materials, with the perforations comprising holes drilled or otherwise formed in the cylinder.

The outer support cylinder 50 is concentrically spaced from the inner support cylinder 48 and defines a fluid exit 56 around the exterior circumference of the cylinder 50. The outer support cylinder 50 may also be formed of a metal mesh, with the perforations comprising openings in the mesh, or may be formed of other suitable materials, with the perforations comprising holes drilled or otherwise formed in the cylinder. In some embodiments, an additional filter medium 58 may be wrapped around the outer diameter of the outer support cylinder 50.

The volume between the inner support cylinder 48 and the outer support cylinder 50 defines a central fluid passageway 60. The filter medium 52 is positioned in the central fluid passageway 60.

An embodiment of the filter medium 52 may be formed of fiberglass, microglass, polypropylene, polyester, or similar material and includes a number of pleats having legs of varying length. The different length legs are configured to maximize the surface area of the filter medium exposed to the fluid stream so that the media velocity through the coalescer can be maximized.

In the illustrated embodiment of the invention, the pleats are M-shaped with a repeating pattern of two long pleats 62 each formed by two relatively longer pleat legs followed by a short pleat 64 formed by two relatively shorter pleat legs. With this configuration, each short pleat 64 is surrounded by two relatively longer pleats 62. The long pleats 62 have pleat tips 62A and 62B that touch both the inner and outer supports 48, 50, whereas the short pleats 64 have tips 64A that touch the outer support 50 and other tips 64B that are suspended between the inner and outer supports 48, 50. In embodiments where the filter medium is formed of one continuous piece of material, adjacent pleats share a pleat tip.

This design is particularly advantageous for coalescers where the flow is inside-out. This concept cannot be used to maximize capacity if the flow is from the outside-in because the pleat tips need to be supported in the direction of flow, and for a short pleat, there is no support for the short pleat if the flow is outside in. However, if the flow is inside out, the short pleats are supported. In other embodiments, the pleats all have tips that touch the inner support. Such a design is preferable for coalescers where the flow is outside-in.

The pattern of the pleats can vary, as can the length of the pleats, as long as the filter medium 52 includes different length pleats. For example, in some embodiments, the pattern may include one long pleat and one short pleat, and in some other embodiments, the pattern may include two or more long pleats followed by one short pleat, or two or more short pleats followed by one long pleat. The length of the short pleats may also be configurable. In some embodiments, the length of the short pleats may be between about 10% and about 90% of the length of the long pleats.

Operation of the coalescer 10 and one of filter cartridges 46 will now be described. Gas or liquid streams from a gas or liquid processing facility flow into the inlet port 12 and inlet chamber 14 and then into the fluid entry passageway 54 of the filter cartridge. The fluid then flows through the perforated inner support cylinder 48, through the filter medium 52, and finally through the outer support cylinder 50 and filter 58 before exiting the coalescer through the effluent chamber 16 and outlet port 18. As the fluid stream passes through the filter medium, liquid contaminants in the fluid stream coalesce on the filter medium and exit the filter cartridge after which they are collected and removed from the coalescer via the drain 20.

In some of the above-described embodiments, fluids flow from the inside of each filter cartridge to the outside of the cartridge in a preferential flow configuration whereby the fluid velocity does not accelerate through the filter cartridge. The coalescer is designed such that liquid contaminants that are captured by the filter cartridges drains in a direction that is substantially gravitationally cross-current or counter current to the primary fluid flow. However, because the continuous phase fluid exits each of the filter cartridges radially, the coalesced liquid droplets do not soak into any lower located filter cartridges but instead move around a filter cartridge on cushions of fluid exiting that filter cartridge. In other embodiments, fluids flow from the outside of the filter cartridges to the insides.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of mediums is not necessarily limited to only those mediums but may include other mediums not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A filter cartridge for a coalescer, the filter cartridge comprising:
an inner support cylinder defining a fluid entry passageway;
an outer support cylinder concentrically spaced from the inner support cylinder, the outer support cylinder defining a fluid exit;
the inner support cylinder and the outer support cylinder defining a central fluid passageway between the fluid entry passageway and the fluid exit;
a filter medium positioned in the central fluid passageway between the inner cylinder and the outer cylinder, the filter medium comprising a plurality of pleats, wherein some of the pleats have lengths greater than other of the pleats.

2. The filter cartridge as set forth in claim 1, wherein the filter medium is formed of a material selected from the group consisting of fiberglass, microglass, polypropylene, and polyester.

3. The filter cartridge as set forth in claim 1, wherein the pleats are M-shaped.

4. The filter cartridge as set forth in claim 1, wherein the pleats have a plurality of pleat tips, wherein some of the pleat tips touch the inner support cylinder, some of the pleat tips touch the outer support cylinder, and some of the pleat tips don't touch either the inner support cylinder or the outer support cylinder.

5. The filter cartridge as set forth in claim 1, wherein the inner support cylinder is perforated.

6. The filter cartridge as set forth in claim 1, wherein the outer support cylinder is perforated.

7. A filter cartridge for a coalescer, the filter cartridge comprising:
an inner, perforated, support cylinder defining a fluid entry passageway;
an outer, perforated, support cylinder concentrically spaced from the inner support cylinder, the outer support cylinder defining a fluid exit;
the inner support cylinder and the outer support cylinder defining a central fluid passageway between the fluid entry passageway and the fluid exit;
a filter medium positioned in the central fluid passageway between the inner cylinder and the outer cylinder, the filter medium comprising a plurality of joined pleats, each pleat having at least one leg, wherein the legs of some of the pleats are longer than the legs of other pleats.

8. The filter cartridge as set forth in claim 7, wherein the filter medium is formed of a material selected from the group consisting of fiberglass, microglass, polypropylene, and polyester.

9. The filter cartridge as set forth in claim 7, wherein the pleats are M-shaped.

10. The filter cartridge as set forth in claim 7, wherein the pleats have a plurality of pleat tips, wherein some of the pleat tips touch the inner support cylinder, some of the pleat tips touch the outer support cylinder, and some of the pleat tips don't touch either the inner support cylinder or the outer support cylinder.

11. The filter cartridge as set forth in claim 7, wherein the inner support cylinder is perforated.

12. The filter cartridge as set forth in claim 7, wherein the outer support cylinder is perforated.

13. A filter cartridge for a coalescer, the filter cartridge comprising:
an inner, perforated, support cylinder defining a fluid entry passageway;
an outer, perforated, support cylinder concentrically spaced from the inner support cylinder, the outer support cylinder defining a fluid exit;
the inner support cylinder and the outer support cylinder defining a central fluid passageway between the fluid entry passageway and the fluid exit;
a filter medium positioned in the central fluid passageway between the inner cylinder and the outer cylinder, the filter medium comprising a plurality of joined M-shaped pleats.

14. The filter cartridge as set forth in claim 13, wherein the filter medium is formed of a material selected from the group consisting of fiberglass, microglass, polypropylene, and polyester.

15. The filter cartridge as set forth in claim 13, wherein the pleats are M-shaped.

16. The filter cartridge as set forth in claim 13, wherein the pleats have a plurality of pleat tips, wherein some of the pleat tips touch the inner support cylinder, some of the pleat tips touch the outer support cylinder, and some of the pleat tips don't touch either the inner support cylinder or the outer support cylinder.

17. The filter cartridge as set forth in claim 13, wherein the inner support cylinder is perforated.

18. The filter cartridge as set forth in claim 13, wherein the outer support cylinder is perforated.
